(19) United States
(12) Patent Application Publication
(10) Pub. No.: US 2023/0069406 A1
(43) Pub. Date: Mar. 2, 2023

(54) INTELLIGENT PREDICTIVE A/B TESTING

(71) Applicants: Anatoli Chklovski, Mill Creek, WA (US); Douglas Cohen, Marina Del Rey, CA (US); Jie Liu, Claremont, CA (US)

(72) Inventors: Anatoli Chklovski, Mill Creek, WA (US); Douglas Cohen, Marina Del Rey, CA (US); Jie Liu, Claremont, CA (US)

(21) Appl. No.: 17/412,792

(22) Filed: Aug. 26, 2021

(51) Int. Cl. G06Q 30/02; G06F 16/28

(52) U.S. Cl. CPC G06Q 30/0201; G06F 16/285; G06Q 30/0204

(57) ABSTRACT

An A/B testing system is adapted to include a user correlation engine and an A/B test exposure module. The A/B testing system includes an A/B test server that provides at least one A/B test to users of a product and collects and analyzes results of the A/B test(s) to determine an outcome. The user correlation engine clusters the users into behavioral clusters based on an activity level of the users with the product. The behavioral clusters include at least high engagement users and lower engagement users. The results of the A/B test(s) for the high and lower engagement users are correlated to identify correlations between at least one high engagement user and at least one lower engagement user. The A/B test exposure module allocates the A/B test exposures to at least the high engagement users based on the identified correlations to optimize the A/B test exposures across the A/B test(s).

### TECHNICAL FIELD

Examples set forth in the present disclosure relate to A/B testing. More particularly, but not by way of limitation, the present disclosure describes techniques for integrating user correlation with A/B test evaluation to decrease the run time of A/B tests and to increase statistically significant data collection.

### BACKGROUND

A/B testing is a user experience research methodology that includes a randomized experiment with two variants, A and B. A/B testing compares two or more variants of a single variable (e.g., a page of a social media application) shown to users at random, typically to test the subject's response to variant A against variant B and determining which of the two variants is more effective. Variant A might be a version used at present and thus forming a control group, while variant B is modified in some respect versus variant A. For example, the variants may include varied copy text, layouts, images, and colors for online website features. Statistical analysis is used to determine which variation performs better for a given conversion goal. A/B testing is commonly used for understanding user engagement and satisfaction relating to online features like a new feature or product and the results of such tests are evaluated to make user experiences more successful.

### BRIEF DESCRIPTION OF THE DRAWINGS

Features of the various implementations disclosed will be readily understood from the following detailed description, in which reference is made to the appended drawing figures. A reference numeral is used with each element in the description and throughout the several views of the drawing. When a plurality of similar elements is present, a single reference numeral may be assigned to like elements, with an added lower-case letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1 illustrates a block diagram of an example A/B testing system;

FIG. 2 illustrates a block diagram of an intelligent A/B testing system in an example configuration;

FIG. 3 illustrates a flow chart for intelligent A/B testing in an example configuration; and

FIG. 4 illustrates an example configuration of a computer system adapted to implement the A/B testing framework in accordance with the systems and methods described herein.

### DETAILED DESCRIPTION

A/B testing has become the gold standard for decision making and has a well-developed evaluation framework. A/B testing has ushered in a new paradigm in software development as companies that adopt A/B testing have significant advantages over those that do not. However, conventional A/B testing largely ignores user correlations in decision making, treating each user as entirely independent from all others. Accordingly, an A/B testing process was developed that incorporates user correlations in decision making to transform conventional A/B testing to be almost an order of magnitude more efficient, in terms of time and sample population.

The A/B testing techniques described herein capitalize on using extra information that is normally discarded in conventional A/B testing processes. For example, the techniques described herein use captured behavioral data to drastically improve statistical power over conventional variance reduction methods. With an advanced understanding of how users coalesce into behavioral clusters, a comparatively small slice of highly engaged users (top 10-20% of most active users) may be created that are highly representative of the entire user base to achieve similar results.

The controlled experiment using pre-experiment data (CUPED) method utilizes pre-experimental data along with existing user segmentation (e.g., geographic, demographic) to increase statistical power. Other methods utilize covariates to increase statistical power (e.g., multiple metrics that tend to be correlated also can be combined to increase statistical power). By contrast, the framework proposed herein integrates user correlation with test evaluation in order to decrease test run time and to increase statistically significant data collection, as well as to provide sharing of user trial resources among simultaneously running A/B tests.

In addressing these issues, this disclosure is directed to systems and methods for A/B testing using an A/B testing system adapted to include a user correlation engine and an A/B test exposure module. The A/B testing system includes an A/B test server that provides at least one A/B test relating to at least one new product feature to users of a product, collects and analyzes results of the A/B test(s) to determine an outcome, and provides the outcome of the at least one A/B test for implementation of a new product feature. The user correlation engine clusters the users into behavioral clusters based on an activity level of the users with the product. The behavioral clusters include at least high engagement users and lower engagement users. The results of the A/B test(s) for the high and lower engagement users are correlated to identify correlations between at least one high engagement user and at least one lower engagement user. The A/B test exposure module allocates the A/B test exposures to at least the high engagement users based on the identified correlations to optimize the A/B test exposures by auctioning the additional A/B test exposures for the at least one A/B test to at least the high engagement users or across the at least one A/B test and across high engagement users.

The following detailed description includes systems, methods, techniques, instruction sequences, and computer program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and methods described because the relevant teachings can be applied or practiced in a variety of ways. The terminology and nomenclature used herein is for the purpose of describing particular aspects only and is not intended to be limiting. In general, well-known instruction instances, protocols, structures, and techniques are not necessarily shown in detail.

The term “connect,” “connected,” “couple,” and “coupled” as used herein refers to any logical, optical, physical, or electrical connection, including a link or the like by which the electrical or magnetic signals produced or supplied by one system element are imparted to another coupled or connected system element. Unless described otherwise, coupled, or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element integrated into or supported by the element.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

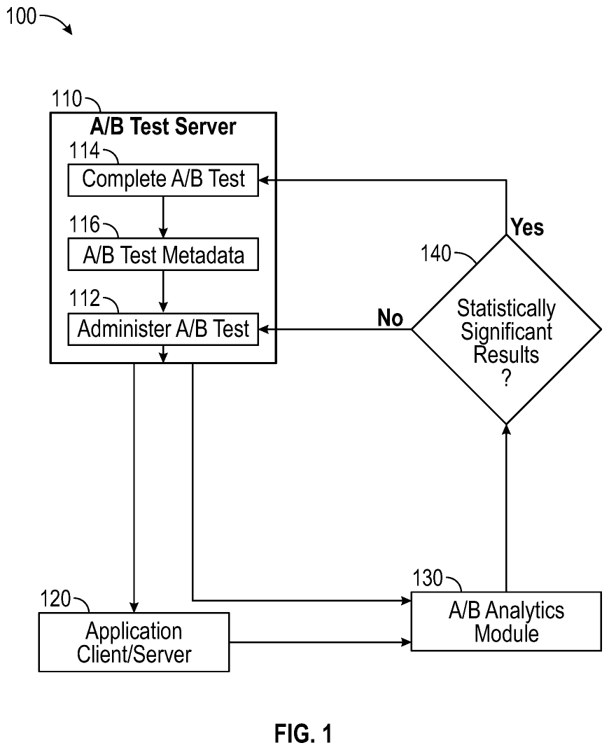

Reference now is made in detail to the examples illustrated in the accompanying drawings and discussed below. Sample configurations will be described with respect to FIGS. 1-4.

### Intelligent Predictive AB Testing

The systems and methods described herein recognize that smart use of collected behavioral data might offer a way to drastically improve statistical power over conventional variance reduction methods used in A/B testing. Intuitively, it is known that a user of online products tells more about themselves via application usage patterns than typical geographic and demographic data ever could. With an advanced understanding of how users coalesce into behavioral clusters, a comparatively small slice of highly engaged users may be created that are highly representative of the entire user base. As a result, similar A/B test results may be achieved with 10-20% of the users required in a conventional A/B Test. As in fractal patterns, a subset of users may be found that mimic the total user population.

In an online environment, it is common for a majority of users to participate in a small number of behavioral strategies. When thinking about users engaged in A/B tests, it can be assumed that certain users react similarly when receiving a new A/B test treatment based on these common behavioral strategies. For example, user XY and user ZA may have similar behavior patterns and, as a result, may tend to respond similarly to certain types of A/B tests. In effect, it can be assumed that if user XY responds positively to a certain test treatment that there is a measurable probability that user ZA also will respond positively to the same test treatment. Thus, if an A/B test runs long enough, then both user XY and user ZA will see the same test treatment and their reaction can be known as opposed to predicting their reaction with a precalculated probability. If user XY and user ZA both have the same engagement level, e.g., visit an application every day, then this user similarity may not be very valuable for a particular A/B test. However, if user XY engages with the application more often than user ZA, then their correlation will be more valuable to the test result. For instance, if user XY uses the application many times a day while user ZA uses the application only a handful of times per week, a reasonable, more useful prediction of user ZA's test reaction may be obtained well in advance of exposing user ZA to a given A/B test.

In practice, many highly engaged users may correlate with less engaged users like user ZA, in effect providing a more confident assessment of user ZA's reaction to an A/B test. However, it may also be found in practice that user XY correlates with many less engaged users, thus each A/B test exposure to user XY may become more valuable based on the inferred user reactions. In the aggregate, the results of an A/B test may be predicted before many less engaged users are exposed to the A/B test by unlocking the hidden value in the highly engaged users being exposed to the A/B tests.

In such an approach, correlation models are used to calculate user similarity between highly engaged users and medium engaged users. (It may be assumed that low-level engaged users do not have enough data to have reliable correlations.) The complexity of these models is significantly reduced since interest lies mainly in user similarity between highly engaged users and medium engaged users, thereby allowing a significant reduction from standard O(n²).

Evaluation of the correlation models is fairly straightforward, and one can look at past A/B tests to see how well user correlations predicted actual user response. Assuming user correlations do accurately predict user response, then one can measure how much sooner the A/B test result would have been known given these correlations. For example, a certain correlation model may produce correlations that allow one to predict the results of the A/B test in 80% of the total test run time. Combining orthogonal correlation models might yield even better results, e.g., a 50% reduction in total test run time.

There are many types of correlation models that may be used in sample configurations. For example, one or more of the following correlation models may be used:

1. User Vector of Factorized Behavioral Metrics-calculates user similarity using a portfolio of transformed metrics;

2. Test Reaction Similarity-users who react to a test similarly are correlated;

3. Test Exposure Similarity Graph-users who are exposed to the same tests are correlated;

4. Correspondence between User Clusters-instead of 1-to-1 comparisons, groups of users are created who are similar; and

5. Similarity & Correspondence-a combination of similarity graph with correspondence models.

Once a strong correlation engine working side by side with the traditional A/B testing evaluation framework has been obtained, the A/B test exposures for highly engaged users become a valuable commodity.

In a conventional A/B test configuration, A/B tests run continuously, and users are exposed to many tests with an eye towards reaching as many users as possible (within test allocations). Since highly engaged users may be used to infer reactions from medium engaged users, how these highly engaged users are exposed across various A/B tests may be optimized in order to maximize the information coming from the A/B test platform. As used herein, “optimized” means to improve the efficiency but not necessarily to provide an optimal result. For instance, one A/B test might be failing to show results after ample exposures. Therefore, this one A/B test may be throttled down in order to increase traffic to another A/B test which was started recently. Thus, instead of each test working independently, the A/B tests may be viewed more globally as part of an auction system in which the A/B platform delivers highly engaged user exposures in an efficient way. In effect, the A/B test exposures are viewed as a scarce resource that is carefully allocated across active A/B tests and across highly engaged users.

While auctions usually involve third parties, as used herein “auction” means an internal auction of sorts in which different A/B tests are given the opportunity to expose users. Such “auctions” optimize the information return of the entire A/B testing system by ensuring that the A/B tests do not draw more information than is needed to come to a conclusion. The A/B tests that are inconclusive do not continue to drain the system, while A/B tests that are promising are given valuable exposures to users.

In sample configurations, the systems and methods described herein may capitalize on predictable user similarity to seriously speed up the time required to achieve statistically significant results for A/B tests. In effect, a given user's response to an A/B test may be inferred without ever exposing the user to the A/B test by preliminary development of strong correlations to other already tested users who act as a good proxy. Exact mechanisms for developing these correlations are discussed in the aforementioned correlation models. Additionally, by treating the A/B test exposures as a valuable commodity to be optimized, the A/B testing time may be globally optimized across the entire A/B test platform.

Currently, in a sample configuration, a median daily active user may be exposed to a plurality of experiments on a given day, with a significant percentage being exposed to many tests. The distribution of the experiments may be optimized using the techniques described herein.

In sample configurations, any of the correlation models mentioned above may be applied to determine user similarity. For example, the user test reaction may be evaluated using the Test Reaction Similarity Model. In this model, users are defined as similar if they respond similarly to a given A/B test. In other words, the users tend to react similarly when exposed to a particular A/B test treatment. However, calculating correlations across all user pairs is computationally expensive, so the problem is reduced by calculating correlations between users within certain groups. As noted above, more information (signal) is available for highly engaged users, while less signal is available for less engaged users. The similarity between certain highly engaged users and medium engaged users, or between medium engaged users and other medium engaged users, may be calculated. Comparisons of highly engaged users to other highly engaged users may be disregarded, and less engaged users may be disregarded altogether due to lack of signal.

As used herein, “engagement” is defined as active in multiple periods of activity whereas less engaged would be active in fewer periods of activity. By way of example, highly engaged users may be defined as the 10-20% most active users, while medium engaged users would be the next 50-60% of the most active users, and the low engaged users would be the remaining users. Of course, other ranges may be defined for the highly and medium engaged users based on the collected data. For example, 4-hour windows or other hourly periods may be used to provide reasonable differentiation of users into engagement groups by activity periods.

In another example, the user test reaction may be evaluated using a Test Exposure Similarity Graph Model. In this model, users are nodes and common A/B tests are weighted edges in the graph structure. If two users share five A/B tests and do not share two A/B tests, their edge weight is 5/7. Highly and moderately engaged users will tend to have a high degree of overlap without much coverage for lowly engaged users. This model is good because highly and moderately engaged users represent most of the A/B test signal. However, this model does not permit generalization across the entire population of users.

Stronger models may be developed to speed up the results for some A/B tests. For example, another model may include an algorithm for calculation of similarities between users. Yet another model may use correspondence between specially created groups of users as opposed to calculating one to one similarity correspondence between users. Another model may implement both approaches to calculate similarity and work with groups of users.

The type of A/B test should also be considered. Some A/B tests are designed to see if any metrics are negative and, if not, to otherwise launch a product. For example, the A/B test may relate to a backend change that is not user facing. In this case, there is no positive indicator to isolate. Also, many A/B tests have several treatment variations. In such cases, the approach may be to only compare the “best” treatment to control. Also, the A/B test should not be biased towards less active users.

In addition, the test outcome may be considered when selecting the A/B test. Most A/B tests have some kind of goal in mind, e.g., increase in average revenue by a certain percentage, but generally the A/B tests also look for unforeseen declines in other metrics. For instance, revenue may be increased at the expense of some other engagement metric. Thus, the users may be correlated with negative as well as positive indicators.

Once the A/B tests are selected, the users are bucketed into activity level buckets (e.g., which users are highly active versus medium active) for the purpose of sizing the gain from correlating highly active users to medium active users in the system. In a sample configuration, user activity in 4-hour windows may be determined to establish the density of user activity within a calendar day. In an example, an active user may be found in 30% or ⅓ of these intervals over the course of a week. The number of periods of activity may be counted and a histogram provided to identify distributions of users in the time periods. Thus, for periods of 4 hours over a total period of a week (42 periods), the probability that a user is seen in any period is calculated. The weight of the user and the weight of the period is also calculated. Of course, some frequent users may not comply with a normal weekly cycle. Such users cannot be extrapolated. To partially address this issue, the weekly data may be split into two parts, one part working week (28 periods) and the other part non-working hours (e.g., 14 periods over the weekend) and two charts created, one with 28 periods and the other with 14 periods. Each chart would track user activity over the respective time periods. New tables may be redone with A/B test exposure data.

Once the tables are completed, high-frequency users versus mid-frequency users may be evaluated. For example, the high-frequency users may be the 25% most active users while the mid-frequency users may be the next 50% most active users. The high-frequency users would then be correlated to identify the mid-frequency users that shadow the high-frequency users. A frequent user A may be correlated with users B, C, and D. The correlation could be positive or negative. When the correlation is positive, two users act similarly. On the other hand, when the correlation is negative, the users tend to act opposite each other. An example of this might be that user X tends to dislike choices may be user Y and vice-versa. An average correlation and extreme negative or positive correlation could be considered to identify 10, 20, 50, etc. A/B tests that are positively or negatively correlated for the users. The total set for these A/B tests is determined where the numerator includes cases where the respective users act together (+) or differently (−) and the denominator includes cases where the users share the same A/B test for a standard set of A/B tests. To assure non-random results, two or three groups of 50 A/B tests may be used. A first collection of results may be used to define tables and the general collection of tests. One-third of the results may be randomly selected and used as the first collection. The high-resolution data may be stored for the A/B tests. The A/B tests may be run for a significant period of time, such as at least a week, to ensure the non-randomness of the results.

The results may be put into the correlation table to identify similar and different users for each test. At a halfway point of the test, a shadow of high-frequency users may be extrapolated onto the mid-frequency users for results where the mid-frequency users have not had results. Then the second half of the test may be performed including the newly generated results. At each checkpoint, the results are checked. At a set point (e.g., at 80%), the test results may again be checked and extrapolated.

A conventional A/B test platform may perform some simple computations. For example, once a user is exposed to a particular A/B test, the A/B test platform may calculate the test metrics for this user since the user's first exposure to the particular A/B test. If a user was exposed to the particular A/B test one week ago, the user's test metrics may be calculated every day since that exposure in today's data. Using this methodology, the test metrics that were above control in the test may be determined. However, this approach may need to be modified to implement user correlations as described herein. The A/B test platform may be modified to look for some event to happen directly after the A/B test exposure. For example, once a user is exposed, the A/B test platform may look to see if the user has taken some action X minutes following exposure. This method seems to work best for signal amplification, whereas the conventional cumulative approach tends to deaden the signal. With this approach, for each A/B test the A/B test platform will need to decide within a designated number of minutes (or hours) after exposure what the desired event will be. Unfortunately, this approach may cause difficulty in determining if other forms of engagement are negatively impacted.

If this small time window approach is used, the signal of an AB Test may be amplified. For example, to see how well user correlations predict test outcomes (e.g., back-testing), this approach may be used to better discern if this correlation model is predictive of test results.

In sample configurations, the A/B test platform calculates the correlation distance between users instead of whether certain behaviors are above or below a threshold. If the correlation distance is smaller than a designated threshold, then the users may be treated as similar for purposes of continued A/B testing. The A/B test platform may calculate all distances between users and determine a median based on distribution. When results are taken from different A/B tests, a measure of the similarity between the A/B tests also may be considered and applied to a linear correlation function. For example, take the domain of a given metric, e.g., metric values varying from 1-100. Split the domain into 10 buckets either by frequency or distance. If distance is used, the buckets will be 1-10, 11-20, 21-30, . . . , 91-100. If user AX falls in bucket 3 and user YZ falls in bucket 7, their distance can be calculated as 7−3=4 and can be assigned a score based on that calculation. For instance, anything less than 5 is 1 and anything equal to 5 is 0 and anything greater than 5 is −1. Of course, the parameters of this simple example may be tuned (e.g., number of buckets, score computation, etc.).

FIG. 1 illustrates a block diagram of an example A/B testing system 100. The A/B testing system 100 may be a standalone system or may be portable to different platforms. In a sample configuration, the A/B testing system 100 includes an A/B test server 110, an application client/server 120, and an A/B analytics module 130. The A/B test server 110 administers A/B tests using testing module 112. In typical A/B testing systems 100, up to hundreds of A/B tests are administered simultaneously throughout the user population and the results collected for analysis. The A/B testing may be iterated to improve speed. The testing module 112 responds to application requests providing a user treatment group when the user is in an active A/B test. Randomization is generally deterministic based on the user profile information. In sample configurations, each user is consistently assigned to the same group based on the user profile information, and a record is maintained every time a given user participates in an A/B test treatment group. In sample configurations, the user profile information may include user demographic data, what shows or programs the user watches, past online activity, and the like. When statistically significant test results have been collected indicating that the A/B test has been completed, the complete A/B test module 114 further marks the current A/B test iteration as complete and either finishes the A/B test or begins a next iteration of the A/B test. Completion of the A/B test triggers A/B test metadata module 116 to collect metadata for the completed A/B test. Such metadata may include targeted users, percentage of users in each treatment group, randomization parameters, evaluation metrics, completion status, test version number, and the like. The results of the A/B test may then be provided to the product application for implementation of a new product feature based on the results.

The application client/server 120 provides A/B test exposure to the users triggered within application logic of the user's application program (e.g., social media application software). The user's application program will behave differently based on the assigned treatment group (A or B) for the A/B test. The application client/server 120 further records relevant behaviors taken by the user subsequent to the A/B test exposure. The recorded behaviors are then aggregated and provided to the A/B analytics module 130.

The A/B analytics module 130 compares an evaluation metrics control to the metrics obtained by the respective treatment groups. Unrelated metrics also may be checked for regressions. The evaluation metrics are used to determine the success or failure of the A/B test once statically significant results are available. Once statistically significant results of the A/B test are determined to be available at 140, the analytics data is provided to the complete A/B test module 114 of the A/B test server 110 for further processing as described above. On the other hand, if statistically significant results of the A/B test are determined at 140 to be unavailable, the test administration is continued. This process repeats until the statistically significant results are available and the A/B test is terminated.

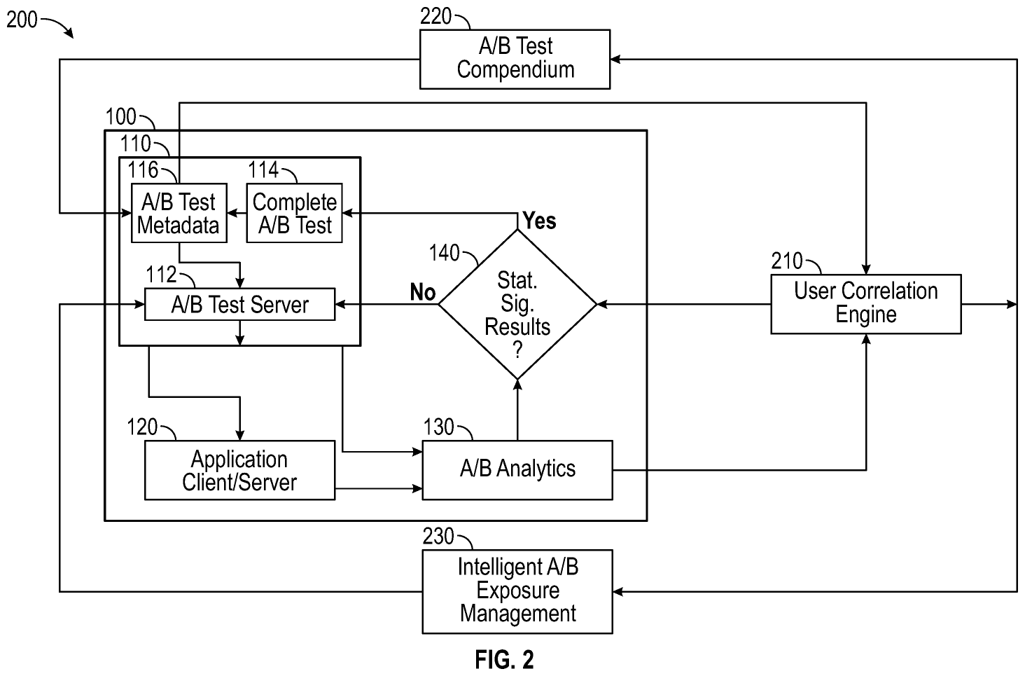

FIG. 2 illustrates a block diagram of an intelligent A/B testing system 200 in sample configurations. As illustrated, the intelligent A/B testing system 200 includes the A/B testing system 100 of FIG. 1 but is further modified to include user correlation engine 210, A/B test compendium 220, and intelligent A/B exposure management system 230.

In sample configurations, the user correlation engine 210 calculates user correlations using a variety of methodologies as described above. For example, the correlation models may include one or more of: User Vector of Factorized Behavioral Metrics, Test Reaction Similarity, Test Exposure Similarity Graph, Correspondence between User Clusters, and Similarity & Correspondence models. In sample configurations, the A/B tests provide Boolean (e.g., yes/no) responses indicating the user's reaction to the A/B test. The correlation results indicate that different users have had the same reaction to the same test. These correlation results are cross-validated by the user correlation engine 210 against existing A/B test results to prove the predictive value of the user correlations. Example user correlations may be implemented by conventional algorithms including cosine similarity based on a semantic profile and test outcome similarity based on user reactions to certain types of A/B tests. The user correlations then may be used to impute A/B test results for mid-level engaged users based on real results from highly engaged users, as described above. Such imputation of A/B test results enables faster A/B test iterations and faster predictions of the outcomes as less waiting is required to collect the user reactions to the A/B test.

The A/B test compendium 220 is an informative catalog of A/B test results including how well the user correlation engine 210 has performed for certain classes of A/B test. As noted above, the correlation results may not be consistent across different A/B tests. The A/B test compendium 220 may be used to formalize A/B testing strategy to specifically influence the types of A/B tests that will be relied upon by the A/B test server 100.

The correlation models may be trained specifically to predict certain types of A/B tests. For example, the similarity model may be trained differently for each type of A/B tests. It may be discovered that certain types of A/B tests are easier to predict than others, or deeper insights may be gained into what users react to certain types of A/B tests. In effect, the A/B testing company may develop strategic intelligence for these different A/B tests. Currently business intelligence does not understand sets of A/B tests and how similar groups of users react to them in a formal and systematic way. The intelligent A/B exposure management module 230 may be used to optimize the A/B test exposures based on the user correlations. For example, as A/B test exposures to highly engaged users are identified as a valuable commodity by the intelligent A/B testing system 200, the A/B test exposures are balanced across A/B tests for the highly engaged users based on gathered knowledge of user correlations and A/B test results. In some configurations, the historical user data based on past A/B test behaviors may be used to predict the user's responses (and the responses of highly correlated users) to an upcoming A/B test. In addition, the A/B test exposures may be auctioned by the intelligent A/B exposure module 230 using auctioning software whereby the test exposures are delivered to highly engaged users in an efficient way. For example, A/B test exposures have more value for high level users, which is considered relative to the success metrics when allocating the A/B test exposures. Similarly, some A/B tests may be determined to have better test criteria and hence a high value, which is considered in the A/B test exposure allocation.

As an example, existing A/B testing systems re-expose highly engaged users to the same test hundreds of times while less engaged users are exposed only once. In the efficient system described herein, highly engaged users would only be exposed only a handful of times or even just once if that is all that is needed. From that data, the reaction of less engaged users may be inferred. By extension, the system can be intelligent in that exposures to highly engaged users may be treated as very valuable and the information return (similar to monetary return or return on investment) from these highly engaged users may be maximized. In effect, the A/B test system is optimized to maximize the information output. In this manner, the A/B test exposures are allocated across one or more active A/B tests and across highly engaged users in a meaningful, statistically-driven probabilistic approach using standard probability algorithms as opposed to randomly, thus preventing the over (or under) exposure of highly engaged users relative to the opportunities available. In other words, the A/B test exposures of active users may be used and reused to complete a given A/B test faster and to allocate A/B test exposures to other A/B tests sooner. The A/B test results may be used to improve existing A/B tests without requiring the development and administration of new A/B tests. The resulting knowledge base may be stored in the A/B test compendium 220 to provide for more efficient testing and better results when applied to future A/B testing as any future A/B testing need not be started from scratch. The results of the A/B test also may be provided to the product application for implementation of a new product feature based on the results.

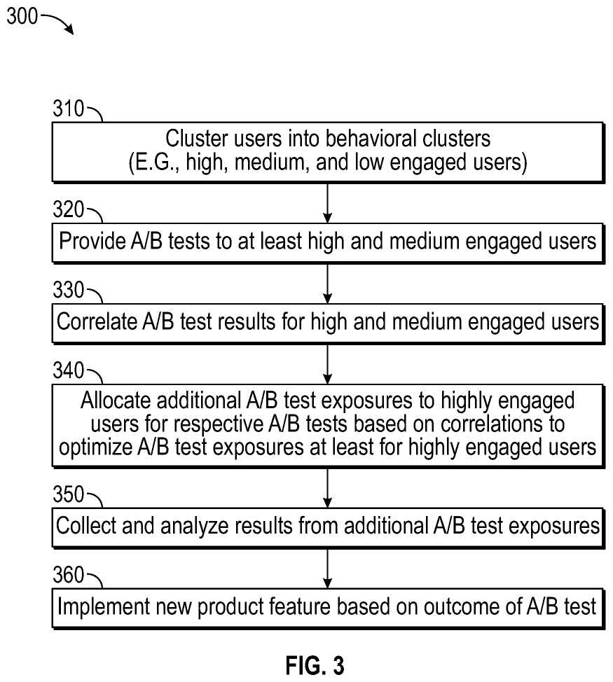

FIG. 3 illustrates a flow chart 300 for intelligent A/B testing in sample configurations. As illustrated, the A/B test server 100 clusters users into behavioral clusters at 310 based on their activity level with a particular application. As noted above, the activity level may be indicative of a level of user engagement measured during multiple time periods in a set time period such as a week. For example, the users may be categorized into highly engaged users, medium engaged users, and lightly engaged users. The A/B tests are then provided by the AB test server 100 to at least the highly engaged users and medium engaged users at 320. The A/B test results are correlated by the correlation engine 210 at 330 for the highly and medium engaged users to identify correlations between at least one highly engaged user and at least one medium engaged user. As noted above, a number of different correlation methods may be used to establish any similarities between highly engaged users and mid-level engaged users. At 340, the intelligent A/B exposure management module 230 allocates additional A/B test exposures for at least one additional A/B test to at least the high engagement users based on the identified correlations to optimize the A/B test exposures for at least the high engagement users. The results of the A/B test exposures are then collected and analyzed at 350 from the additional A/B test exposures to determine an outcome of the at least one additional A/B test. For example, the results may be used to determine the effect of the launch of a new feature for the particular application. The outcome of the A/B test may be used at 360 to implement the new feature of the particular application.

It will be appreciated by those skilled in the art that the systems and methods described herein not only reduce the number of users required for A/B testing, but simultaneously provide a significant acceleration in the time frame for A/B testing, thereby enabling the A/B testing to be extended into new areas. For example, evolving treatments for the same users adding dynamic optimization may be inserted into the testing strategies, e.g., multi-armed bandits. On the other hand, treatments may be better customized for different groups of users in view of the heterogeneous treatment effects often seen in A/B tests.

Those skilled in the art will further appreciate that there are some limitations to the approach described herein as there are cases in which user similarity might need to be defined very carefully. For example, if a server-side/backend change is gated with no user facing change using an A/B test, the user correlations may not be used effectively to predict A/B test results. These “smoke tests” that purely focus on ensuring sound technical functionality are probably not a great use case for this methodology, since the common behavioral strategies will not impact a user's reaction to these tests. In general, any A/B test relevant to this methodology should have meaningful user facing changes in order for user correlation framework because the common behavioral strategies will tend to be predictive. User facing A/B tests do comprise the majority of A/B testing, so this limitation is not confining.

Those skilled in the art will also appreciate that the system described herein is not limited to any particular type of correlation model. The correlation models mentioned herein were provided as examples only. Many more could easily be plugged into this system provided they have predictive value for A/B tests. It will be appreciated that some correlation models may provide pure noise while other correlation models may predict certain types of A/B tests well. Also, ensembles of correlation models may be used to capture different types of similarity all at once.

The techniques described herein enable correlation and evaluation to work together to produce A/B test results, enabling the A/B testing to become faster as well as more reliable. Creating a new paradigm in which A/B test exposures are allocated in an efficient, optimized manner in order to fast track results may provide testing power that is significantly improved with respect to conventional A/B testing.

System Configuration

Techniques described herein may be used with one or more of the computer systems described herein or with one or more other systems. For example, the various procedures described herein may be implemented with hardware or software, or a combination of both. For example, at least one of the processor, memory, storage, output device(s), input device(s), or communication connections discussed below can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

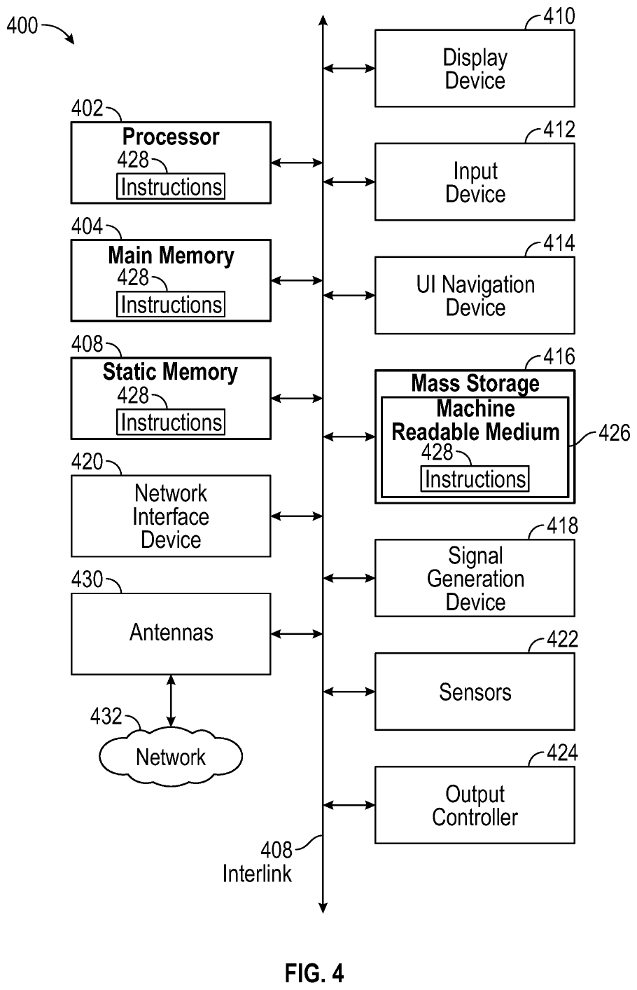

By way of example, FIG. 4 illustrates a sample configuration of a computer system 400 adapted to implement the A/B testing platform in accordance with the systems and methods described herein. In particular, FIG. 4 illustrates a block diagram of an example of a machine 400 upon which one or more configurations may be implemented. In alternative configurations, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. In sample configurations, the machine 400 may be a personal computer (PC), a tablet PC, a set-top box (STB), a personal digital assistant (PDA), a mobile telephone, a smart phone, a web appliance, a server, a network router, switch or bridge, or any machine capable of executing instructions (sequential or otherwise) that specify actions to be taken by that machine. For example, machine 400 may serve as a workstation, a front-end server, or a back-end server of a communication system. Machine 400 may implement the methods described herein by running the software used to implement the A/B testing platform described herein. Further, while only a single machine 400 is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, processors, logic, or a number of components, modules, or mechanisms (herein “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. The software, when executed by the underlying hardware of the module, causes the hardware to perform the specified operations.

Accordingly, the term “module” is understood to encompass at least one of a tangible hardware or software entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display device 410 (shown as a video display), an alphanumeric input device 412 (e.g., a keyboard), and a user interface (UI) navigation device 414 (e.g., a mouse). In an example, the display device 410, input device 412 and UI navigation device 414 may be a touch screen display. The machine 400 may additionally include a mass storage device (e.g., drive unit) 416, a signal generation device 418 (e.g., a speaker), a network interface device 420, and one or more sensors 422. Example sensors 422 include one or more of a global positioning system (GPS) sensor, compass, accelerometer, temperature, light, camera, video camera, sensors of physical states or positions, pressure sensors, fingerprint sensors, retina scanners, or other sensors. The machine 400 may include an output controller 424, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 416 may include a machine readable medium 426 on which is stored one or more sets of data structures or instructions 428 (e.g., software) embodying or utilized by any one or more of the techniques or functions described herein. The instructions 428 may also reside, completely or at least partially, within the main memory 404, within static memory 406, or within the hardware processor 402 during execution thereof by the machine 400. In an example, one or any combination of the hardware processor 402, the main memory 404, the static memory 406, or the mass storage device 416 may constitute machine readable media.

While the machine readable medium 426 is illustrated as a single medium, the term “machine readable medium” may include a single medium or multiple media (e.g., at least one of a centralized or distributed database, or associated caches and servers) configured to store the one or more instructions 428. The term “machine readable medium” may include any medium that is capable of storing, encoding, or carrying instructions for execution by the machine 400 and that cause the machine 400 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM (compact disc read only memory) and DVD-ROM disks. In some examples, machine readable media may include non-transitory machine-readable media. In some examples, machine readable media may include machine readable media that is not a transitory propagating signal.

The instructions 428 may further be transmitted or received over communications network 432 using a transmission medium via the network interface device 420. The machine 400 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone Service (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas 430 to connect to the communications network 432. In an example, the network interface device 420 may include a plurality of antennas 430 to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

The features and flow charts described herein can be embodied in one or more methods as method steps or in one more applications as described previously. According to some configurations, an “application” or “applications” are program(s) that execute functions defined in the programs. Various programming languages can be employed to generate one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating systems. In this example, the third-party application can invoke API (Application Program Interface) calls provided by the operating system to facilitate functionality described herein. The applications can be stored in any type of computer readable medium or computer storage device and be executed by one or more general purpose computers. In addition, the methods and processes disclosed herein can alternatively be embodied in specialized computer hardware or an application specific integrated circuit (ASIC), field programmable gate array (FPGA) or a complex programmable logic device (CPLD).

Program aspects of the technology may be thought of as “products” or “articles of manufacture” typically in the form of at least one of executable code or associated data that is carried on or embodied in a type of machine readable medium. For example, programming code could include code for the touch sensor or other functions described herein. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the programming, media content or meta-data files includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to “non-transitory,” “tangible,” or “storage” media, terms such as computer or machine “readable medium” refer to any medium that participates in providing instructions or data to a processor for execution.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD (Digital Versatile Disk) or DVD-ROM, any other optical medium, punch cards paper tape, any other physical storage medium with patterns of holes, a RAM, a PROM (Programmable Read Only Memory) and EPROM, a FLASH-EPROM, any other memory chip or cartridge, a carrier wave transporting data or instructions, cables or links transporting such a carrier wave, or any other medium from which a computer may read at least one of programming code or data. Many of these forms of computer readable media may be involved in carrying one or more sequences of one or more instructions to a processor for execution.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method of providing A/B testing relating to at least one new product feature to users of a product, comprising:
clustering the users into behavioral clusters based on an activity level of the users with the product, the behavioral clusters including at least high engagement users and lower engagement users;
providing at least one A/B test to at least the high engagement and lower engagement users;
correlating results of the at least one A/B test for the high engagement and lower engagement users to identify correlations between at least one high engagement user and at least one lower engagement user;
allocating additional A/B test exposures for at least one additional A/B test to at least the high engagement users based on the identified correlations to optimize the A/B test exposures for at least the high engagement users;
collecting and analyzing results of the additional A/B test exposures to determine an outcome of the at least one additional A/B test; and
implementing a new product feature based on the outcome of the at least one additional A/B test.

2. The method of claim 1, wherein correlating results of the at least one A/B test for the high engagement and lower engagement users comprises applying results of the at least one A/B test to at least one of the following correlation models: User Vector of Factorized Behavioral Metrics, Test Reaction Similarity, Test Exposure Similarity Graph, Correspondence Between User Clusters, or Similarity and Correspondence.

3. The method of claim 1, wherein correlating results of the at least one A/B test for the high engagement and lower engagement users comprises determining a correlation distance between at least one high engagement user and at least one lower engagement user, comparing the correlation distance to a threshold distance, and treating the least one high engagement user and at least one lower engagement user as similar for purposes of continued A/B testing when the correlation distance is less than the threshold distance.

4. The method of claim 1, wherein allocating additional A/B test exposures for the at least one additional A/B test comprises auctioning the additional A/B test exposures for the at least one additional A/B test to at least the high engagement users.

5. The method of claim 3, wherein allocating additional A/B test exposures for the at least one additional A/B test comprises auctioning the additional A/B test exposures across the at least one additional A/B test and across high engagement users.

6. The method of claim 1, further comprising cross-validating the results of correlating the at least one A/B test for the high engagement and lower engagement users against existing A/B test results to prove a predictive value of the results of correlating the at least one A/B test for the high engagement and lower engagement users.

7. The method of claim 6, further comprising storing results of the at least one A/B test and storing results of the additional A/B test exposures for correlated high engagement and lower engagement users.

8. The method of claim 1, further comprising predicting results of correlated users to the additional A/B test exposures based on results of the at least one A/B test.

9. The method of claim 1, wherein the at least one A/B test relates to lens personalization, further comprising tracking a lens send and a lens swipe as results of the at least one A/B test.

10. An A/B testing system comprising:
an A/B test server that provides at least one A/B test relating to at least one new product feature to users of a product, collects and analyzes results of the at least one A/B test to determine an outcome of the at least one A/B test, and provides the outcome of the at least one A/B test for implementation of a new product feature;
a user correlation engine that clusters the users into behavioral clusters based on an activity level of the users with the product, the behavioral clusters including at least high engagement users and lower engagement users and correlates results of the at least one A/B test for the high engagement and lower engagement users to identify correlations between at least one high engagement user and at least one lower engagement user; and
an A/B test exposure module that allocates A/B test exposures by the A/B test server to at least the high engagement users based on the identified correlations to optimize the A/B test exposures for at least the high engagement users.

11. The testing system of claim 10, wherein the user correlation engine comprises at least one of the following correlation models: User Vector of Factorized Behavioral Metrics, Test Reaction Similarity, Test Exposure Similarity Graph, Correspondence Between User Clusters, or Similarity and Correspondence.

12. The testing system of claim 10, wherein the user correlation engine includes a processor that executes instructions to determine a correlation distance between at least one high engagement user and at least one lower engagement user and compare the correlation distance to a threshold distance, wherein the A/B test exposure module treats the least one high engagement user and at least one lower engagement user as similar for purposes of continued A/B testing when the correlation distance is less than the threshold distance.

13. The testing system of claim 10, wherein the A/B test exposure module comprises auctioning software that allocates additional A/B test exposures for the at least one A/B test to at least the high engagement users.

14. The testing system of claim 10, wherein the A/B test exposure module comprises auctioning software that allocates additional A/B test exposures across the at least one A/B test and across high engagement users.

15. The testing system of claim 10, wherein the user correlation engine cross-validates the results of correlating the at least one A/B test for the high engagement and lower engagement users against existing A/B test results to prove a predictive value of the results of correlating the at least one A/B test for the high engagement and lower engagement users.

16. The testing system of claim 15, further comprising an A/B test memory that stores results of the at least one A/B test and stores results of the A/B test exposures for correlated high engagement and lower engagement users.

17. The testing system of claim 10, wherein the A/B test server predicts results of correlated users to the additional A/B test exposures based on results of the at least one A/B test.

18. A non-transitory computer-readable storage medium that stores instructions that when executed by at least one processor cause the at least one processor to perform a method of providing A/B testing relating to at least one new product feature to users of a product by performing operations including:
clustering the users into behavioral clusters based on an activity level of the users with the product, the behavioral clusters including at least high engagement users and lower engagement users;
providing at least one A/B test to at least the high engagement and lower engagement users;
correlating results of the at least one A/B test for the high engagement and lower engagement users to identify correlations between at least one high engagement user and at least one lower engagement user;
allocating additional A/B test exposures for at least one additional A/B test to at least the high engagement users based on the identified correlations to optimize the A/B test exposures for at least the high engagement users;
collecting and analyzing results of the additional A/B test exposures to determine an outcome of the at least one additional A/B test; and
implementing a new product feature based on the outcome of the at least one additional A/B test.

19. The medium of claim 18, further comprising instructions that when executed by the at least one processor cause the at least one processor to perform operations including:
applying results of the at least one A/B test to at least one of the following correlation models: User Vector of Factorized Behavioral Metrics, Test Reaction Similarity, Test Exposure Similarity Graph, Correspondence Between User Clusters, or Similarity and Correspondence;
determining a correlation distance between at least one high engagement user and at least one lower engagement user;
comparing the correlation distance to a threshold distance; and
treating the least one high engagement user and at least one lower engagement user as similar for purposes of continued A/B testing when the correlation distance is less than the threshold distance.

20. The medium of claim 18, further comprising instructions that when executed by the at least one processor cause the at least one processor to perform operations including at least one of auctioning the additional A/B test exposures for the at least one A/B test to at least the high engagement users or auctioning the additional A/B test exposures across the at least one A/B test and across high engagement users.
